(19) United States
(12) Patent Application Publication
(10) Pub. No.: US 2026/0283401 A1
(43) Pub. Date: Sep. 24, 2026

(54) COOKING DEVICE AND ASSOCIATED METHOD

(71) Applicant: Imtiaz PALEKAR, Hounslow (GB)

(72) Inventor: Imtiaz PALEKAR, Hounslow (GB)

(21) Appl. No.: 19/472,400

(22) PCT Filed: Apr. 5, 2024
(86) PCT No.: PCT/GB2024/050926

§ 371 Date: Oct. 3, 2025

(30) Foreign Application Priority Data
Apr. 5, 2023 (GB) 2305081.8

(51) Int. Cl. A47J 37/06; A47J 27/08; A47J 27/086

(52) U.S. Cl. CPC A47J 37/0641; A47J 27/0817; A47J 27/086

(57) ABSTRACT

A cooking device (10) for cooking food which comprises a cooking chamber (12), a heating element (34), and a compressor (16, 18) for cooking food under elevated temperature, pressure and air velocity.

The present invention relates to a cooking device. The invention further relates to a method of cooking food under elevated heat, elevated pressure, and elevated air velocity.

It is desirable to cook food rapidly and economically, particularly in a domestic setting. Air fryers, which utilise hot, air to cook, are increasingly used for this purpose.

However, there are numerous problems with the use of air fryers.

Air fryers can take a longer duration of cooking time, for example between 15 and 20 minutes, compared to conventional methods, such as in a frying pan or deep fat fryers.

Additionally, air fryers can be loud, for example operating at between 60 and 90 decibels, due to the ventilator drawing in ambient air which circulates inside the pan before exiting. This can also create odours during cooking.

Air fryers can be difficult to clean since existing systems are typically not modular.

Air fryers have a low volumetric cooking efficiency, and as such are too small for larger families since on average; they can cater for four helpings per use of the device.

Cooking with an air fryer can lack consistency and can be difficult, since it is often a trial-and-error process, especially when the weight of ingredients is not taken into account, during the cooking cycle, leading to poor results.

Air fryers are relatively bulky for the volume of product that they cook, for example typically having dimensions of around 287 mm×315 mm×384 mm.

Pressure cookers are also known, which cook food at an elevated pressure and therefore reduce cooking time. However, pressure cookers are only used when cooking in water-based cooking liquids, and require the pressure to be generated by heating of the liquid to generate high-pressure steam. As such, pressure cookers have limited controllability and limited application.

The present invention seeks to provide a solution to these problems.

According to a first aspect of the present invention, there is provided a cooking device for cooking food, the cooking device comprising: a cooking chamber for receiving food, the cooking chamber having an access opening for receiving food therethrough and a cover, the access opening being sealably closeable by the cover so that the cooking chamber is pressurisable when the access opening is closed by the cover; a heating means for heating the cooking chamber; a mechanical pressurisation means for pressurising the cooking chamber; and a mechanical air-moving means for moving air within the cooking chamber.

The cover makes an air-tight seal. The environment inside the cooking chamber can therefore reach an elevated pressure, temperature and air velocity or speed. This results in a reduced cooking time, by as much as 70%. Since a mechanical pressurisation means is provided, the pressure can be adjusted independently of temperature. Additionally, the device has an improved energy efficiency over conventional air fryers, for example an improvement of 25%.

The device may work at a pressure of 0 to 20 psi (138 kPa), though higher pressures are possible depending on the structural integrity of the system. Similarly, velocities can range from 1 m/s to 20 m/s, or 1 m/s to 40 m/s or above depending on operational requirements. Again, there is no upper or lower limit to velocity and is subject to operational requirements.

Preferably, the mechanical pressurisation means and the mechanical air-moving means may be provided by the same component. In other words, the same device, such as a compressor, may provide both air movement in the cooking chamber and increased air pressure.

Advantageously, the mechanical pressurisation and/or the mechanical air-moving means may comprise a compressor. Therefore, the mechanical pressurisation means may comprise a compressor, or the mechanical air-moving means may comprise a compressor, or the mechanical pressurisation means and the mechanical air-moving means may both comprise a compressor respectively.

Optionally, the cooking device may additionally comprise a separate compressor. The further compressor can provide higher pressure to the device if required.

Beneficially, the heating means and/or mechanical pressurisation means may be external of the cooking chamber.

Optionally, the cooking device may comprise a side conduit fluidly communicated with the cooking chamber, and the heating means and/or mechanical pressurisation means may be at or in the side conduit. The side conduit is preferably communicated with the cooking chamber at two openings; an outlet and an inlet. This can provide improved air flow, since air can circulate around the side conduit and the cooking chamber. The side conduit may also be termed as a duct.

Additionally, the heating means may be a heating element which is outside of the side conduit and/or cooking chamber. This may be advantageous, as it prevents the heating element from being affected by a high-pressure environment, and prevents or limits the requirements to have holes through the wall of the side conduit and/or cooking chamber.

In a preferable embodiment, the heating element may be mounted to an exterior surface of the side conduit.

Preferably, an interior surface of the side conduit may have fins for improving a transfer of heat from the heating element to a working fluid inside the side conduit. The fins may be integrally formed from a metal lining of the interior surface. Alternatively, the fins may be attached to the conduit by an interference fit. The working fluid will be understood to be air, along with any entrained cooking liquids. The terms “air” and “working fluid” may be used interchangeable herein throughout.

Beneficially, the fins may have a helical profile for creating a vortex effect. This may improve the transfer of heat between the side conduit and the working fluid.

Advantageously, the device may further comprise a liquid and/or solid separator for separating liquid from air, the liquid and/or solid separator may be between the cooking chamber and the mechanical pressurisation means, mechanical air-moving means, and/or heating element. The liquids may be oil and water or other cooking liquids. The liquid and/or solid separator may also separate solids, such as carburised food particles. By separating the liquids and/or solids from the air, the mechanical pressurisation means and/or mechanical air-moving means may be at least partially protected from clogging by these liquids and solids. Additionally, it may remove the liquids from the air flow cycle to prevent the liquids from being reintroduced to the food.

In a preferable embodiment, the liquid and/or solid separator may comprise a plurality of off-set baffles. For example, there may be a set of off-set baffles, which may have an alternating off-set to prevent or limit the passage of liquid and solids through the liquid and/or solid separator.

Optionally, the liquid and/or solid separator may comprise a removable trap for receiving separated liquid and solids. The removable trap may have a split design. This may allow for easier removal of waste cooking liquids and solids and easier cleaning of the cooking device.

Preferably, the liquid and/or solid separator may comprise a replaceable filter.

Additionally, the cooking device may further comprise an expansion tank or pressure regulator fluidly communicated with the cooking chamber. This may be provided by an expansion tank. As such, if the pressure in the cooking chamber becomes too high then this may be accommodated by the expansion tank to reduce and store the pressure. The stored pressure may be used to assist with re-pressurising the cooking chamber in future uses, providing improved efficiency and quicker start up time.

Preferably, the cooking device may further comprise a blast diverging nozzle between the heating means and/or mechanical air-moving means and the cooking chamber. The nozzle may be considered to be a blast nozzle and may accelerate the flow of air onto the food. The outlet of the nozzle is directed towards the location of the food so that the food can be impinged by the air flow. The divergent nozzle also provides a localised pressure increase helping to force heat into the food.

Optionally, the cooking device may further comprise a hollow heat exchanger for heating liquid, an interior of the heat exchanger being fluidly communicable with the heating means so as to receive hot air therethrough. Hot air from the heating means and/or mechanical air moving means can flow through the heat exchanger, heating the walls of the heat exchanger. This would heat the liquid in which the heat exchanger is submersed. As such, the cooking device can heat liquids. Preferably, the cooking device may further comprise a solid food holder for holding food in the cooking chamber, the food holder having a plurality of openings and being fluidly communicable with the heating means. The food holder allows for more efficient cooking of food since the food can be held at a better position relative to the outlet of the heating means, and may be at a correct orientation. Additionally, since the food holder is here an enclosure with holes therethrough, the hot air may be in contact with the food for a longer duration and over a greater surface area.

Additionally, the hollow heat exchanger and/or the food holder may be disconnectably connectable to the nozzle. This allows for use of different attachments to suit different food preparation requirement. A bayonet attachment system may be used.

Preferably, the hollow heat exchanger may have a helical portion.

Beneficially, the cooking device may further comprise a liquid holder for holding food in the cooking chamber, the liquid holder having a plurality of fins on an outer surface thereof. The fins improve the transfer of heat from the side conduit to the content contained within the liquid holder. Optionally, the heating means may comprise an inductive heating element and the cooking chamber may comprise metal so that the cooking chamber is configured to be inductively heated by the inductive heating element. The cooking chamber walls can therefore transfer heat to the internal air or food. This allows for the heating means to be external from the cooking chamber. Additionally, since there is preferably metal around at least a majority of the cooking chamber, the food can be more evenly heated due to a substantially even distribution of heat from the cooking chamber.

Additionally, an interior surface of the cooking chamber may have fins for improving a transfer of heat from the interior surface to a recirculating working fluid inside the cooking chamber. The fins may be shallow. The fins act as a heat exchanger which is integral to the cooking chamber.

In a preferable embodiment, the mechanical air-moving means may be a fan which may be magnetically supported and magnetically driven externally from the cooking chamber. This allows for the mechanism of the air-moving means to be protected from the high-pressure environment of the cooking chamber. Additionally, it negates the requirement of a hole through the wall of the cooking chamber.

Preferably, the cooking device may be a countertop appliance. As such, the cooking device is portable and small enough to be positioned on a kitchen counter in a domestic setting. Furthermore, the cooking device may have an electrical plug for connecting to an electrical socket or electrical outlet so as to power the device. As such, the cooking device may be powered by the mains electricity supply. Alternatively, the cooking device may be powered by a battery. This may provide greater portability, for example, for use when camping. The battery may be rechargeable. The cooking device may be modular since various parts of the system may be disassembled from each other so as to ease cleaning.

According to a second aspect of the invention, there is provided a method of cooking food under elevated heat, elevated pressure, and elevated air velocity using the cooking device as claimed in any one of the preceding claims.

According to a third aspect of the invention, there is provided a cooking device for cooking food, the cooking device comprising: a cooking chamber for receiving food, the cooking chamber having an access opening for receiving food therethrough and a cover, the access opening being sealably closeable by the cover so that the cooking chamber is pressurisable when the access opening is closed by the cover; a heating means for heating the cooking chamber; and a mechanical pressurisation means for pressurising the cooking chamber.

According to a fourth aspect of the invention, there is provided a cooking device for cooking food, the cooking device comprising: a cooking chamber for receiving food, the cooking chamber having an access opening for receiving food therethrough and a cover, the access opening being sealably closeable by the cover so that the cooking chamber is pressurisable when the access opening is closed by the cover; a heating means for heating the cooking chamber which preferably comprises an inductive heating element, the cooking chamber comprising metal so that the cooking chamber Is configured to be inductively heated by the inductive heating element; and a mechanical air-moving means for moving air within the cooking chamber which preferably comprises a fan which is magnetically supported and magnetically driven externally from the cooking chamber

The invention will now be more particularly described, by way of example only, with reference to the accompanying drawings, in which:

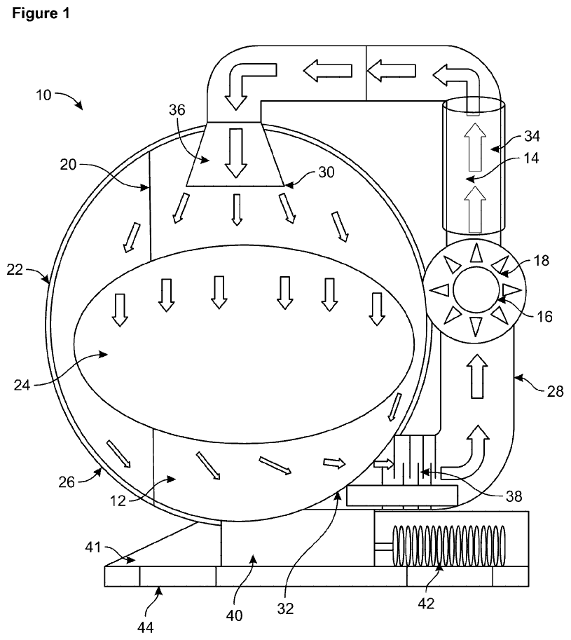

FIG. 1 shows a representation of a first embodiment of a cooking device in accordance with first and third aspects of the invention;

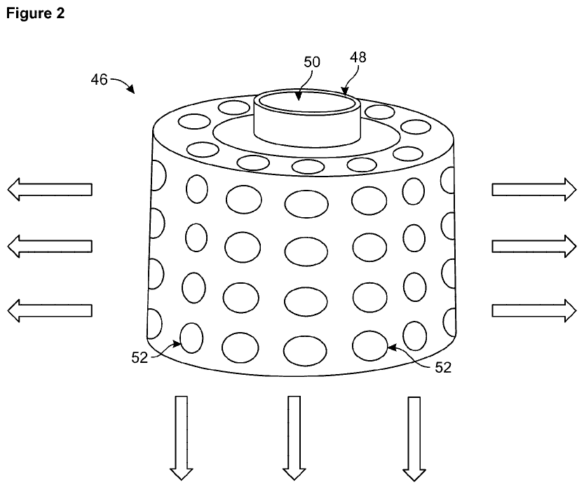

FIG. 2 shows a first embodiment of a food holder for use with the cooking device of FIG. 1;

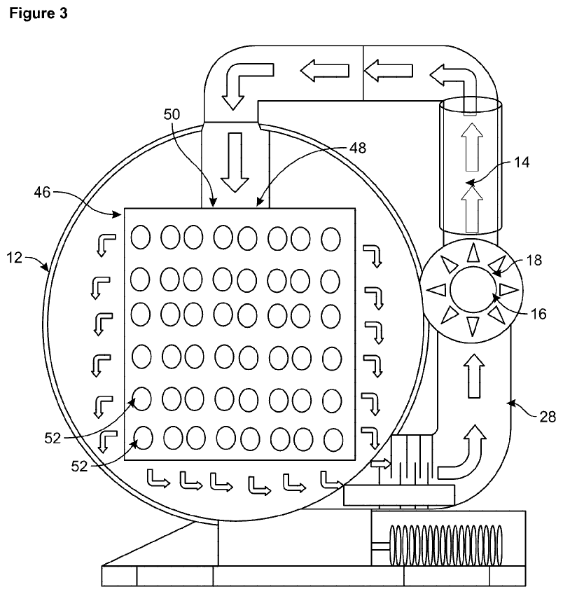

FIG. 3 shows the cooking device of FIG. 1 with the food holder of FIG. 2;

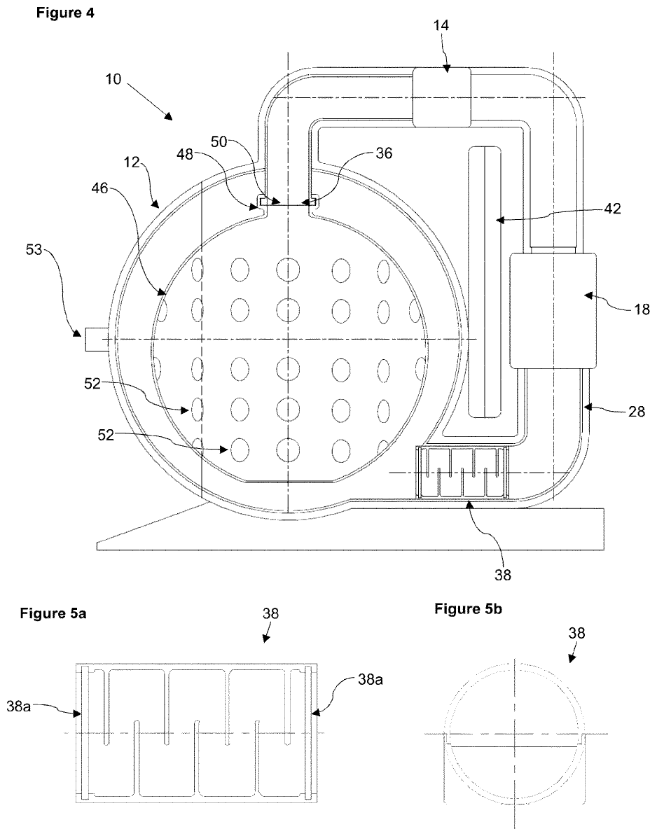

FIG. 4 shows a second embodiment of a cooking device in accordance with first and third aspects of the invention, having a second embodiment of a food holder;

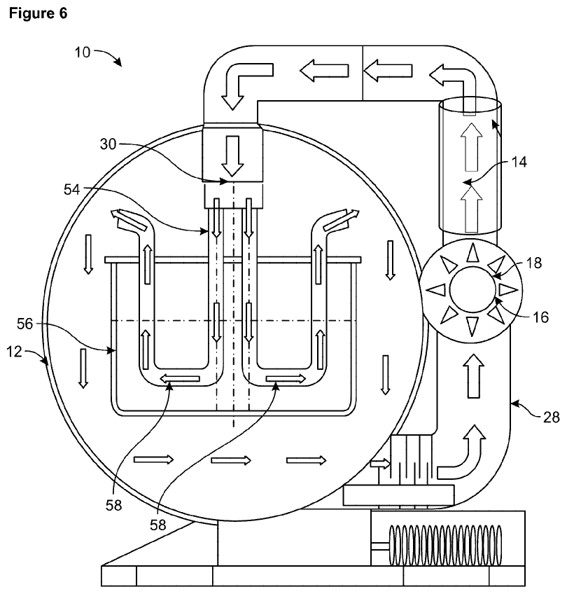

FIG. 5a shows an enlargement of a liquid and/or solid separator of FIG. 4;

FIG. 5b shows an axial view of the liquid and/or solid separator of FIG. 5a;

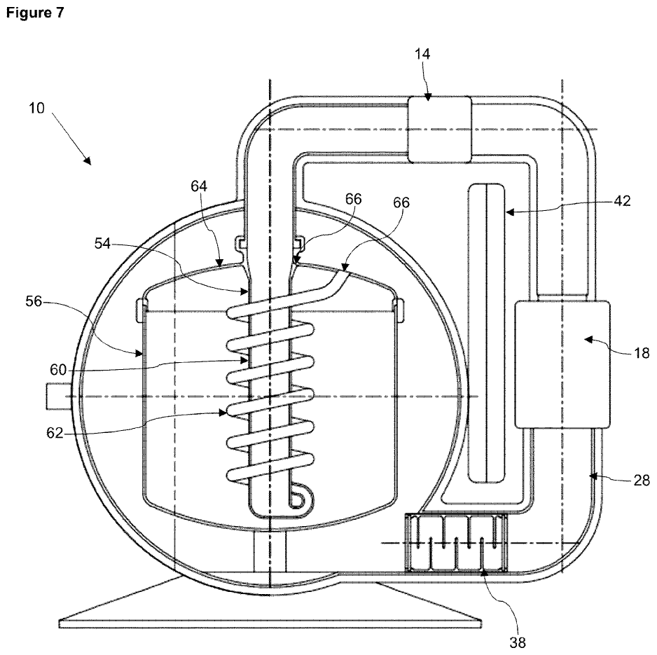

FIG. 6 shows the cooking device of FIG. 1 with a first embodiment of a hollow heat exchanger for heating liquid and a liquid container for receiving liquid;

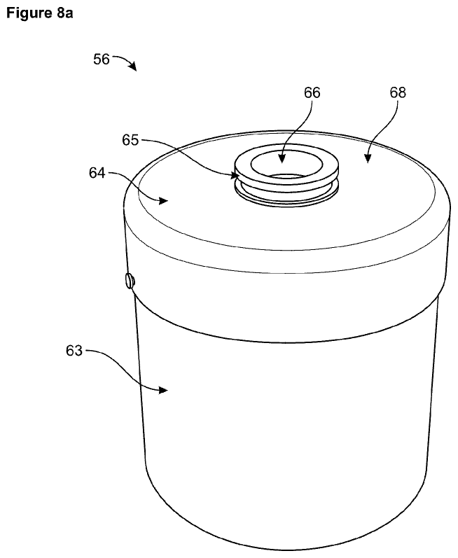

FIG. 7 shows the cooking device of FIG. 4 with a second embodiment of a hollow heat exchanger for heating liquid and a liquid container for receiving liquid;

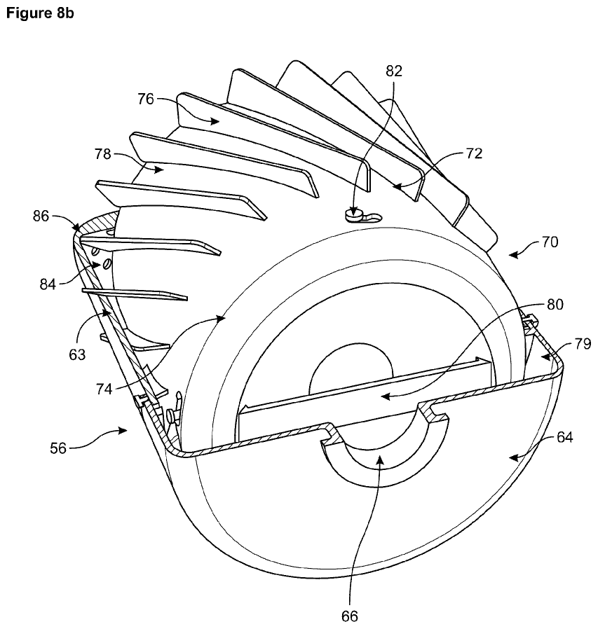

FIG. 8a shows a third embodiment of a liquid container for receiving liquid;

FIG. 8b shows the liquid container of FIG. 8a in section and a liquid holder located within; and

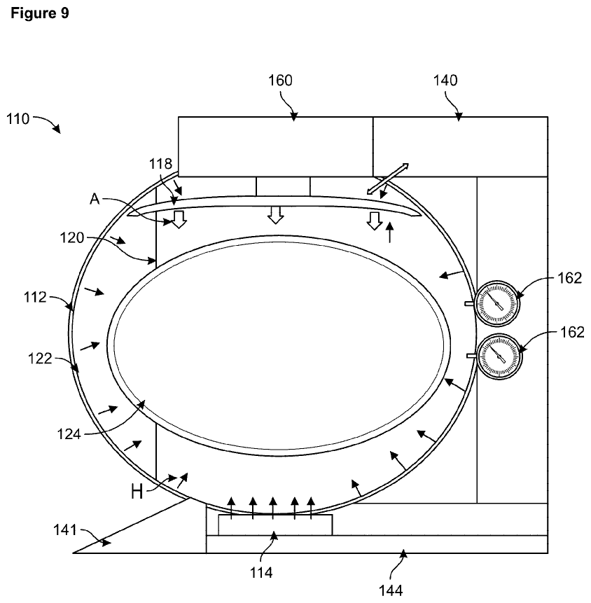

FIG. 9 shows a representation of a third embodiment of a cooking device in accordance with first, third, and fourth aspects of the invention.

Referring firstly to FIG. 1, there is shown a first embodiment of a cooking device 10. The cooking device 10 includes a cooking chamber 12 for receiving food, a heating means 14 for heating the cooking chamber 12, and preferably at least one of a mechanical pressurisation means 16 for pressurising the cooking chamber 12 and a mechanical air-moving means 18 for moving air within the cooking chamber 12.

The first embodiment may be known as a Forced Impingement Pressurised Air Fryer System. The system is configured to work at slightly above atmospheric pressure and with high velocity air.

The cooking device 10 is preferably a countertop device. In other words, the device is small enough to be positioned on a kitchen counter, for example. The cooking device 10 preferably has an electrical plug for connection to an electrical outlet to power the device. Alternatively, the cooking device may be battery operated for added portability.

The cooking chamber 12 has an access opening 20 for receiving food therethrough and a cover 22 for closing the access opening 20. The access opening 20 is sealably closeable by the cover 22 so that the cooking chamber 12 is pressurisable when the access opening 20 is closed by the cover 22. The cover 22 may also be termed as a door or a hatch.

The cooking chamber 12 may have a cooking zone 24, into which hot air is moveable to cook the food. There may be a plate or grill in the cooking zone 24 for receiving the food.

The cooking chamber 12 may be referred to as a pressure vessel since it is configured to withstand the pressure differential between the inside of the cooking chamber 12 and ambient pressure. With the cover 22 closing the access opening 20, the cooking chamber 12 is sealed. To improve the energy efficiency of the device, the cooking chamber 12 has thermal insulation 26, which may be integral, at or adjacent to an exterior surface thereof. Additionally or alternatively, the cooking chamber 12 may be double skinned or double walled. The insulation and/or double wall formation can reduce heat losses to the atmosphere by up to 90%.

The cooking chamber 12 may be cylindrical, spherical or hemispherical, amongst other shapes.

The heating means 14, mechanical pressurisation means 16, and/or the mechanical air-moving means 18 are preferably external of the cooking chamber 12. Here, each of these elements are at or in a side conduit 28 or side chamber. The heating means 14 may be referred to as a heater, the mechanical pressurisation means 16 may be referred to as a mechanical pressurisation element and the mechanical air-moving means 18 may be referred to as a mechanical air-moving element. The cooking chamber 12 has an air inlet 30 for receiving hot air from the side conduit 28, and an air outlet 32 for discharging air back into the side conduit 28. As such, the cooking chamber 12 with the side conduit 28 can preferably form a closed-loop system. The side conduit 28 may be formed from metal and/or have a metal lining. The system can be further fabricated using high temperature polymers such as polyetheretherketone (PEEK).

The mechanical pressurisation means 16 and the mechanical air-moving means 18 preferably take the form of a single element or device, which is here a compressor. The compressor 16, 18 is configured to pressurise the cooking chamber 12 and/or side conduit 28 by drawing in external air and driving it into the side conduit 28. This action therefore moves the air into the cooking chamber 12 and therefore the compressor 16, 18 is also a mechanical air-moving means 18. The compressor 16, 18 may also be configured to move air around the device without creating additional pressure.

The compressor 16, 18 may, for example, be a centrifugal compressor or an axial flow compressor.

There may be localised high-pressure regeneration in the cooking zone 24.

The heating means 14 preferably comprises at least one, and preferably a plurality of heating elements 34. Each heating element 34 is outside of the side conduit 28 and cooking chamber 12. Here the heating elements 34 are at and/or around the exterior surface of the side conduit 28. The heating elements 34 may make up a barrel heater, which has a substantially cylindrical shape.

The heating means 14 is preferably downstream of the mechanical pressurisation means 16 and/or the mechanical air-moving means 18, and is upstream of the air inlet 30 of the cooking chamber 12. The heating means 14 is configured to heat the air in the side conduit 28.

The interior surface of the side conduit 28 may be metal and/or may have fins or be finned so as to improve an exchange of heat from the side conduit 28 to the internal air. The fins further increase surface area for heat transfer. The fins may have a helical profile so as to create a rotating and/or vortex effect to improve heat transfer and flow mixing. The location of the fins may correspond to the location of the heating elements 34 to improve the exchange of heat from the heating elements 34 to the hot air within the side conduit 28.

At the air inlet 30 there is preferably a nozzle 36, which may be considered to be a blast nozzle 36 or blast diverging nozzle 36. The nozzle 36 in this case is a frustoconical and is here a divergent nozzle 36, however depending on the aerodynamic condition required at this point, the nozzle 36 may be convergent, or parallel such as the nozzle being cylindrical in shape. The divergent nozzle 36, or diffuser, decelerates the air flow and increases pressure and temperature relative to the incident flow and expansion ratio. However, the airflow is still considerably faster than the exiting flow, and temperature elevated through pressure recovery.

The airflow is aerodynamically modified by the profile of the side conduit 28 to create a high velocity focused impingement jet at the exit of the nozzle 36.

There is preferably a liquid and/or solid separator 38 for separating liquid, for example oil or water, and/or solids, for example carburised particles or sediment, from air. The liquid and/or solid separator 38 is between the cooking chamber 12 and the compressor 16, 18 and/or heating element 34. As such, the liquid and/or solid separator 38 is preferably at or adjacent to the air outlet 32. The liquid and/or solid separator 38 comprises a plurality of baffles, which are off set from each other. Here there is a series of baffles, for example eight baffles. The liquid and/or solid separator 38 may be modular and/or removable for cleaning. The detachable liquid and/or solid separator 38 can be further disassembled for cleaning or washing and can be augmented by filters between the baffles.

The liquid and/or solid separator 38 preferably includes or is liquidly connected to a removable trap. As such, oil or water can flow to the removable trap which can then be removed and emptied and/or cleaned.

The device 10 preferably comprises a management system 40 for managing temperature, pressure, and velocity or speed of air in the cooking chamber 12 and/or side conduit 28. The management system 40 is preferably electronic and so includes suitable circuitry, such as processors and memory devices, to manage temperature, pressure, and velocity of air. The management system 40 is underpinned by software that processes and monitors the sensor and user inputs to provide optimal cooking conditions and duration to fulfil end-user requirement.

The management system 40 may include a user interface 41 for allowing a user to select different cooking programmes and/or initiate user defined cooking duration that adjusts the temperature, pressure and/or velocity. The user interface 41 may include a graphical display screen and a user control, such as a touch screen or buttons. The user interface 41 may further incorporate voice and remote activation.

The management system 40 receives temperature data from the temperature sensor in the cooking chamber 12. This may allow for the heating means 14 to be activated as and when heat is required to reach a desired temperature and/or to set a suitable heat output of the heating means 14.

The management system 40 preferably comprises a pressure sensor for measuring the pressure in the cooking chamber 12. This may allow for the mechanical pressurisation means 16 to be activated as and when greater pressure is required to reach a desired pressure.

Additionally or alternatively, the management system 40 may include a pressure accumulator 42, such as an expansion tank, to regulate air pressure within the cooking chamber 12.

The management system 40 may include an air velocity sensor for measuring air velocity in the cooking chamber 12. This may allow for the output of the mechanical air-moving means 18 to be automatically adjusted to reach a desired air-speed velocity. Alternatively, there may be no such sensor, and instead the output of the mechanical air-moving means 18 may simply be adjusted based on pre-determined power settings to achieve different estimated air velocities and temperatures.

The management system 40 may include a humidity sensor to monitor the dryness or humidity level of the cooking zone. When necessary, the device will have the ability to introduce moisture from a water storage unit. This will be solenoid operated and controlled by the management system 40.

The management system 40 may include a weight sensor 44, weight cell or electronic weighing scales for weighing the food placed into the cooking chamber 12, and thereby producing weight data.

The management system 40 may include a timer or clock device.

Stored on a memory device of the management system 40, there may be cooking data on the optimum time, temperature, pressure, air velocity, and humidity to cook various foods, preferably depending on weight. The cooking data may be provided for cooking from various initial states, for example fresh or frozen, to various end states, for examples medium, rare or well done. The cooking data may be configured as various cooking programmes. The various cooking programmes may be presented to the user, and selected by the user, via the user interface 41. The cooking programme may be automatically adjusted based on the weight data.

Additionally or alternatively, there may be recipe data, including a list of ingredients and cooking settings, stored on a memory device of the management system 40. Such recipes may be visible to a user via the user interface 41.

The management system 40 may have embedded artificial intelligence software which enables the system to understand and learn end user settings and habits especially with for new recipes. When an end user utilises their own recipe several times to the point that they reach a steady state condition in terms of, start and end cooking states, and user defined cooking duration and weight, the system then creates a default. Once a default state is reached for the user defined recipe, the system will automatically set the cooking duration based on the input and output end user states. The system will be able to interpolate cooking durations based on the empirical data that the system stores during the operator learning period.

The management system 40 may be connectable to the internet, for example via WiFi (RTM), such as WiFi (RTM)-Bluetooth (RTM) smartphone interface, to allow the system to update the onboard cooking data and/or recipe data, stored on a database, to allow user access to improved cooking programmes and new recipes. Users may also create and upload their own cooking programmes and recipes to a community webpage via the internet connection. These may be assessed and approved centrally before being disseminated.

In use, the cover 22 of the cooking chamber 12 can be opened and food positioned inside the cooking chamber 12, in the cooking zone 24, via the access opening 20. The cover 22 is then closed to seal the cooking chamber 12 and side conduit 28 so that the cooking chamber 12 can be pressurised.

The food is automatically weighed by the weight sensor 44, and any cooking programme automatically adjusted based on the weight data.

The user can then select a cooking programme, depending on the food which is to be cooked and the desired start and end food states. Alternatively, the user may manually enter in desired cooking settings.

The compressor 16, 18 then operates to draw external air into the side conduit 28 and move it around the side conduit 28 and cooking chamber 12. This pressurises the cooking chamber 12. The compressor 16, 18 may stop drawing external air into the side conduit 28 and cooking chamber 12 once the desired pressure has been reached. However, despite not creating additional pressure, the compressor 16, 18 may continue to move air around the side conduit 28 and cooking chamber 12 at the pre-determined air velocity.

At the same time, the heating element 34 is activated and heats the side conduit 28, which in turn heats the air inside the side conduit 28.

The hot air is received into the cooking chamber 12 via the nozzle 36, which accelerates the air. The nozzle may create pressurised jet impingement on the food. The food is impinged by the hot air at elevated pressure and speed, which cooks the food.

The high pressure may be achieved in the cooking chamber 12 via the venturi effect. As the high velocity hot air expands in a divergent part of the cooking chamber, the pressure and temperature increase, and the velocity reduces in proportion.

The air flows back into the side conduit 28 via the liquid and/or solid separator 38, which separates oil, water and other cooking liquids from the air. These liquids flow and accumulate in the trap, which can then be emptied and cleaned periodically, for example after each use or after several uses.

In FIG. 1, block arrows indicate a direction of air flow.

The optimum cooking temperature, pressure, and air velocity are maintained via the management system 40 controlling the heating element 34 and compressor 16, 18 based on feedback from the various sensors located in the cooking chamber 12 and the duct or side conduit 28.

Once the management system 40 has determined, via the timer, that food has been cooked for the optimum time, the heating element 34 and compressor 16, 18 are deactivated. The cooking chamber 12 and side conduit 28 may be allowed to return to atmospheric pressure, for example via opening a vent or pressure release valve. The user may open the cover 22 and retrieve the cooked food. The cover 22 can only be opened once the pressure in the chamber 12 equalises with ambient via a pressure activated lock.

Referring to FIGS. 2 and 3, there is provided a food holder 46 which comprises an enclosure. The food holder 46 is fluidly communicable with, connectable to and supportable by the air inlet 30 of the cooking chamber 12 and/or the nozzle 36 so as to receive hot air directly into the enclosure. The food holder is connectable by a connector 48, for example via a bayonet connection. The food holder 46 itself therefore has an air inlet 50, which may be co-located with the connector 48. Air can then flow out of the food holder 46 through an air outlet 52 of the food holder 46, having transferred heat to the food.

The air outlet 52 may comprise a plurality of apertures, which may be considered to be perforations or similar. There may be several apertures which may be distributed around the enclosure to ensure an even distribution of air through the enclosure. The apertures have a non-uniform pitch and location and are designed to be located to maximise the heat transfer to the food. For example, there will be fewer outlet apertures facing the exit suction port and more on the opposite side to encourage a uniform distribution and exit of the recirculating flow.

The food holder 46 is cylindrical, or substantially cylindrical, and may be termed a colander. Several geometries, for example spherical, are available depending on cooking need.

Food may be positioned inside the food holder 46 via a hinged opening, such as a door or by using clamshell-push fit structure.

In FIGS. 2 and 3, block arrows indicate a direction of air flow.

Referring to FIG. 4, there is shown a second embodiment of a cooking device 10 having a second embodiment of a food holder 46. The second embodiment of the cooking device and of the food holder are similar to the first embodiments, and therefore the same reference numerals are used.

The second embodiment of the food holder is spherical or substantially spherical, although it may have a flat lower surface. The second embodiment of the food holder is otherwise similar to the first embodiment, having a connector 48 to connect to the nozzle 36 of the cooking device 10, an air inlet 50, and a plurality of air outlets 52.

The air moving means 18 and heating means 14 are indicated for the second embodiment of the cooking device 10, although it will be appreciated that their positions may be reversed.

The pressure accumulator or expansion tank 42 is shown at or adjacent to a side wall of the cooking chamber 12.

The cooking chamber may be openable via a handle or latch 53 or similar.

The second embodiment of a cooking device 10 may have a management system 40 as described previously.

The liquid and/or solid separator 38 is shown in more detail in FIGS. 5a and 5b. The liquid and/or solid separator 38 may have a replaceable filter 38a, or may have a cascade filter. The replaceable filter 38a may be at the upstream and/or downstream ends of the solid separator 38. The solid separator 38 may have a generally circular cross-section as shown in FIG. 5b. The liquid and/or solid separator 38 may be removable from the rest of the cooking device 10 for ease of cleaning.

Referring to FIG. 6 there is shown a heat exchanger 54 for heating liquid connected to the air inlet of the cooking chamber 12. The heat exchanger 54 is hollow. An interior of the heat exchanger 54 is fluidly communicable with, connectable to and supportable by the air inlet 30 of the cooking chamber 12 and/or the nozzle 36 so as to receive hot air therethrough. This may be via a bayonet connection. The heat exchanger 54 preferably comprises of a hollow tubes. The heat exchanger has several geometries, for example spiral or finned, to optimise for specific cooking needs.

A liquid container 56 is provided for receiving liquid. The container 56 may be supportable by the heat exchanger 54 and/or the container 56 may be supportable by the cooking chamber 12.

The hollow tube has a return 58. This is so that the tube extends into the container 56 and back out of the container 56.

In use, the user may connect the heat exchanger 54 to the nozzle 36, appropriately position the liquid container 56 in the cooking chamber 12 so that the heat exchanger 54 extends into the container 56, and at least partly fill the liquid container 56 with liquid.

The cooking device 10 is then used as previously described. When hot air exits the nozzle 36, it travels through the heat exchanger 54, heating the liquid, before exiting the tubes and recirculating via the outlet 32.

In FIG. 6, block arrows indicate a direction of air flow.

Referring now to FIG. 7, there is shown the second embodiment of the cooking device with a second embodiment of a heat exchanger 54 and a second embodiment of a liquid container 56. As before, the heat exchanger 54 includes a hollow tube which extends through the liquid container 56 for receiving hot air. The hollow tube has a downwardly extending straight portion 60 which extends into the container 56. This then transitions to an upwardly extending helical or coiled portion 62 which then extends out of the container 56. The helical or coiled portion 62 is for increasing a surface area between the liquid and the tube. The straight portion may have a wider diameter than the helical portion.

The container 56 preferably has a lid 64 having at least one aperture 66 for allowing air from the hollow tube to enter and exit the container. The lid 64 may be connected to the hollow tube.

Referring to FIGS. 8a and 8b, there is shown a third embodiment of a liquid container 56, also referred to as a container 56, for use in the first and second embodiments of the cooking device 10. The cooking device 10 having the third embodiment of the container 56 is used as previously described, and therefore the same reference numerals are used.

The third embodiment of the liquid container 56 does not require an internal heat exchanger as illustrated in FIG. 6 or FIG. 7.

Similar to the second embodiment of the container, the third embodiment of the container 56 preferably comprises container body 63 and a lid 64 for connecting with the container body 63, the lid 64 having a connector 65, for example via a bayonet connection, for connecting the container 56 to the nozzle 36 of the cooking device 10 and at least one aperture 66 on an in use upper surface 68 of the lid 64 for allowing hot air to enter the container 56 from the heating means 14.

In this embodiment, a liquid holder 70 is located or housed in the container 56 as shown in FIG. 8b, for holding food in the cooking chamber 12. The liquid holder 70 is therefore shrouded within the container 56. The container 56 may be referred to as an outer liquid holder shroud, an outer case or an outer shroud. The liquid holder 70 may be referred to as an inner case. The liquid holder 70 is dimensioned to fit inside the container 56. The liquid holder 70 has a liquid-holder body 72 having an opening for receiving food and a liquid-holder lid 74 for closing the opening of the liquid-holder body 72, both of which are preferably metal. The liquid holder 70 can receive and contain liquid food and/or solid food.

A plurality of fins 76 is located on an outer surface 78 of the liquid-holder body 72. The plurality of fins 76 may act as heat exchangers as heat can be transferred from the heating means 14 via the plurality of fins 76 to the liquid-holder body 72 and to the content in the liquid holder 70. Each of the plurality of fins 76 are preferably spaced apart from one another and the arrangement of the plurality of fins 76 has a helical profile for creating a vortex effect when the hot air enters the container 56. The fins 76 are at an angle to the in use vertical but may be parallel to the in use vertical. The fins 76 enhance the heating of the content within the liquid holder 70 as heat transfer is faster due to the larger surface area created. The plurality of fins 76 extends away from the liquid-holder body 72 and may contact an inner surface 79 of the container 56. A space is thus provided between the liquid-holder body 72 and the container 56 to improve the efficiency of movement of hot air around the liquid holder 70 and between the fins 76. The plurality of fins 76 have a planar lateral extent in the embodiment illustrated. Alternatively, one or more fins may have a non-planar lateral extent, such as a wavy shape, to further increase the surface area for heat exchange to take place.

The liquid holder 70 has an engagement means or element 82, for example at least one bayonet connection, to secure the liquid-holder lid 74 to the liquid-holder body 72. The liquid-holder lid 74 preferably comprises a handle 80 which when turned locks or unlocks the liquid-holder lid 74 to the liquid-holder body 72. As an alternative or in addition, a screw threaded engagement may be provided on the liquid holder 70 for releasable engagement of the liquid-holder lid 74 and the liquid-holder body 72.

A plurality of outlets 84 is present on an in use lower surface or base 86 of the container 56 such that hot air which enters the container 56 can exit the container 56 therethrough.

It will be appreciated that the container body 63 of the container 56 and the liquid-holder body 72 of the liquid holder 70 may be connected.

In use, liquid and/or solid food is placed within the liquid-holder body 72 of the liquid holder 70. The liquid-holder lid 74 is secured to the liquid-holder body 72 of the liquid holder 70 by turning the handle 80 of the liquid-holder lid 74 to lock the liquid-holder lid 74 against the liquid-holder body 72 via the engagement means 82.

The liquid holder 70 is then placed within the container 56 and the lid 64 placed onto the container 56 to enclose the liquid holder 70 within the container 56.

The connector 65 of the container 56 is attached to the side conduit 28 via the nozzle 36 of the cooking device 10. When hot air exits the side conduit 28, it travels through the container 56, between the fins 76 and surrounds the liquid holder 70, heating the content within the liquid holder 70. The heating is made more efficient due to the fins 76 on the liquid holder 70 and thus the fins 76 effectively act as the heat exchanger. The hot air flows past the liquid holder 70 and exits the container 56 via the plurality of outlets 84 and the hot air is recirculated.

The first and second embodiments of the cooking device 10 utilising the third embodiment of the liquid container 56 may be known as a Pressurised Air Fryer System (PAFS) as airflow is high pressure and low velocity.

Referring now to FIG. 9, there is shown a third embodiment of a cooking device 110. Similar or identical reference numerals may be used for the third embodiment as for the first embodiment, with 100 added.

The third embodiment of the cooking device 110 may be referred to as a Pressurised Air Fryer System.

Similar to the first embodiment, the third embodiment includes a cooking chamber 112 for receiving food. The cooking chamber has an access opening 120 and a cover 122. Additionally, the third embodiment similarly includes a heating means 114, a mechanical pressurisation means, or air pump, not shown, and a mechanical air-moving means 118.

The cooking chamber 112 has a cooking zone 124 for receiving food and may be similar or identical to the cooking chamber of the first embodiment.

For the third embodiment, it is of particular importance that at least part of the cooking chamber 112 comprises metal. Preferably, at least a majority of a perimeter of the cooking chamber 112 comprises metal or is lined with metal, and most preferably the entire perimeter of the cooking chamber 112 comprises metal or is lined with metal. This is so that at least part of the cooking chamber 112 is configured to be heated via magnetic induction.

Additionally, an interior surface of the cooking chamber 112, which is preferably metal, has shallow fins or is finned so as to improve an exchange of heat from the wall of the cooking chamber 112 to the internal air. The fins further provide channelling to allow the heated flow to recirculate due to the effect of the mechanical air-moving means 118.

The heating means 114 is preferably an induction heating device or inductive heating element, such as an inductive heating coil, which is positioned external to, and at or adjacent to the metal of the cooking chamber 112. The metal of the cooking chamber 112 can thus be inductively heated by the inductive heating element 114. The metal of the cooking chamber 12 can then heat the internal air via the fins.

The mechanical air-moving means 118 may comprise a fan which is inside the cooking chamber 112 but which is magnetically supported and magnetically driven externally from the cooking chamber 112. The device may have a motor and a magnetic coupling 160 external of the cooking chamber 112 so as to drive the fan.

The mechanical pressurisation means 116 may be a compressor or similar.

The third embodiment may further comprise a management system 140 which includes similar or identical components as per the management system 140 of the first embodiment, including a weight sensor or cell 144 and user interface 141.

The management system 140 may further include analogue dials or gauges 162 for indicating pressure and/or temperature, for example.

The third embodiment may be used in a similar or identical manner as the first embodiment. The user may open the cover 122, position food in the cooking zone 124, and then close the cover 122 which seals the cooking chamber 112. The user may then select the desired cooking programme to set the temperature, pressure, air velocity, and cooking time to activate the device. The inductive heating element 114 heats the wall of the cooking chamber 112 which in turn heats the internal air of the cooking chamber 112 via the fins. A flow of heat is indicated by block arrows H inwardly extending from the wall of the cooking chamber 112. The mechanical pressurisation means pressurises the internal air. The fan 118 moves the internal air around the cooking chamber 112. A flow of air is indicated by block arrows A.

It may be further possible to utilise the liquid holder 70 illustrated in FIG. 8a and FIG. 8b, but without the liquid container 56, for holding food in the cooking chamber 112 of the third embodiment of the cooking device 110, preferably in the cooking zone 124.

This process cooks the food. The third embodiment preferably cooks the food under a higher pressure and lower air velocity than the first embodiment.

It is therefore possible to provide a countertop cooking device which cooks food at an elevated temperature, pressure and air velocity for reduced cooking speed and improved cooking quality and controllability.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A cooking device for cooking food, the cooking device comprising:
a cooking chamber for receiving food, the cooking chamber having an access opening for receiving food therethrough and a cover the access opening configured to be closed by the cover so that the cooking chamber is configured to be pressurised when the access opening is closed by the cover
a heating element configured to heat the cooking chamber
a mechanical pressurisation element configured to pressurise the cooking chamber and
a mechanical air-moving element configured to move air within the cooking chamber

2. A cooking device as claimed in claim 1, wherein the mechanical pressurisation element and the mechanical air-moving element are provided by the same component.

3. A cooking device as claimed in claim 1, wherein at least any one of the mechanical pressurisation and/or the mechanical air-moving element comprises a compressor.

4. A cooking device as claimed in claim 1, wherein at least any one of the heating element and/or mechanical pressurisation element are external of the cooking chamber.

5. A cooking device as claimed in claim 4, wherein the cooking device comprises a side conduit fluidly communicated with the cooking chamber, at least any one of the heating element and/or mechanical pressurisation element being any one of at or in the side conduit.

6. A cooking device as claimed in claim 5, wherein the heating heating element which is outside of at least any one of the side conduit and/or cooking chamber.

7. A cooking device as claimed in claim 6, wherein the heating element is mounted to an exterior surface of the side conduit.

8. A cooking device as claimed in claim 5 7, wherein an interior surface of the side conduit has fins configured to improve transfer of heat from the heating element to a working fluid inside the side conduit-(28), wherein the fins have a helical profile for creating a vortex effect.

9. (canceled)

10. A cooking device as claimed in claim, further comprising a separator configured to separate at least any one of liquid and/or solid from air, the separator being between the cooking chamber and at least any one of the mechanical pressurisation element mechanical air-moving element and/or heating element

11. A cooking device as claimed in claim 10, wherein the solid-separator comprises a plurality of off-set baffles.

12. (canceled)

13. (canceled)

14. (canceled)

15. A cooking device as claimed in claim 1, further comprising a blast diverging nozzle between at least any one of the heating element and/or mechanical air-moving element, and the cooking chamber

16. A cooking device as claimed in claim 1, further comprising a hollow heat exchanger for heating liquid, an interior of the heat exchanger configured to be fluidly communicated with the heating element so as to receive hot air therethrough.

17. A cooking device as claimed in claim 16, wherein the hollow heat exchanger has a helical portion.

18. A cooking device as claimed in claim 1, further comprising a food holder for holding food in the cooking chamber the food holder having a plurality of openings and being fluidly communicable with the heating element-means

19. A cooking device as claimed in claim 16, further comprising a blast diverging nozzle between at least any one of the heating element and mechanical air-moving element, and the cooking chamber, wherein the hollow heat exchanger is configured to be connected to and disconnected from disconnectably the blast diverging nozzle

20. A cooking device as claimed in claim 1, further comprising a liquid holder for holding food in the cooking chamber the liquid holder having a plurality of fins on an outer surface thereof.

21. A cooking device as claimed in claim 1, wherein the heating element comprises an inductive heating element and the cooking chamber comprises metal so that the cooking chamber is configured to be inductively heated by the inductive heating element.

22. A cooking device as claimed in claim 1, wherein an interior surface of the cooking chamber has fins for improving a transfer of heat from the interior surface to a recirculating working fluid inside the cooking chamber.

23. A cooking device as claimed in claim 1, wherein the mechanical air-moving element is a fan which is magnetically supported and magnetically driven externally from the cooking chamber

24. (canceled)

25. A method of cooking food under elevated heat, elevated pressure, and elevated air velocity using the cooking device as claimed in claim 1.
